(19) United States
(12) Patent Application Publication
(10) Pub. No.: US 2011/0057873 A1
(43) Pub. Date: Mar. 10, 2011

(54) FLEXIBLE ELECTRONIC DEVICE AND METHOD FOR THE CONTROL THEREOFF

(76) Inventors: Jan Geissler, Riemerling (DE); Johannes Faerber, Neubiberg (DE)

(21) Appl. No.: 12/734,125

(22) PCT Filed: Oct. 9, 2008
(86) PCT No.: PCT/EP2008/063555

§ 371 Date: Oct. 25, 2010

(30) Foreign Application Priority Data
Oct. 10, 2007 (DE) 10 2007 048 596.6

(51) Int. Cl. G06F 3/01

(52) U.S. Cl. 345/156

(57) ABSTRACT

The present invention relates to a flexible electronic device (10), for example, a flexible display appliance that is bendable, at least in regions, in at least one bending direction (11, 12). In order to create a simple input possibility for an interaction with electronic device (10), which is as direct and intuitive as possible and which will be able to dispense with previously common input means having a technical appearance, such as, for example, switches, knobs, controllers and similar means, electronic device (10) has at least one bending sensor element (14) for detecting the bending state of at least one region of flexible electronic device (10) and a control mechanism for converting the bending values detected by the at least one bending sensor element (10) into control commands. In addition, a method is also described for controlling such an electronic device (10).

The present invention first relates to a flexible electronic device, which is bendable, at least in regions, in at least one bending direction. In addition, the invention relates to a method for controlling a flexible electronic device.

Flexible electronic devices of the named type are known, for example, in the form of flexible display appliances, for example, flexible displays.

In this respect, a mobile apparatus that can process information is described in DE 102 24 143 A1. The information particularly involves texts and images, which can be stored and presented. The apparatus first comprises a housing produced from flexible material and a flexible display element. In addition, the apparatus has a flexible plate on which are located the electronics that control and make possible the operation of the apparatus. Additionally, the apparatus has a wireless interface which is suitable for local data communication. The apparatus is operated over an operating field which provides suitable input means and navigation input means. Input means involve, for example, individual keys, a joystick or similar means.

Known solutions of this type involve technical input means, for example, switches, knobs, controllers and similar means, whereby the input means, on the one hand, greatly influence the device character. On the other hand, such input means, of course, are also sensitive to dirt contamination, moisture, deposits and similar contaminants. This is a disadvantage for the operation of such flexible apparatuses, particularly when they are used as flexible display appliances.

Additional known solutions are based on controlling the device by tilting or shaking it. For example, acceleration sensors are utilized in portable computers for the protection of the hard disk. In the meantime, such sensors have also been used for controlling applications by moving the device. In these solutions, however, it is a disadvantage that a disciplined behavior of the user is a prerequisite. In addition, these types of controls are easy to activate unintentionally.

Flexible electronic devices, for example, in the form of flexible electronic display appliances, e.g., in the form of flexible displays, make possible novel portable display devices having a rather non-technical appearance.

Proceeding from the named prior art, the object of the present invention is based on providing a flexible electronic device as well as a method for controlling a flexible electronic device, which permits a simple operation and which, by avoiding the above-described disadvantages, acts directly and intuitively, but does not contribute to an overall technical appearance. In particular, a simple input possibility will be created for interaction with the electronic device, an input which is as direct and intuitive as possible and which will dispense with the previously common input means having a technical appearance, such as, for example, switches, knobs, controllers and similar means.

This object will be accomplished according to the invention by the flexible electronic device with the features according to the independent patent claim 1, as well as by the method for controlling a flexible electronic device with the features according to the independent patent claim 13. Further features and details of the invention can be taken from the subclaims, the description and the drawings.

Features and details that are described in connection with the flexible electronic device according to the invention, of course, also apply in connection with the method according to the invention for controlling a flexible electronic device, and vice versa, so that everything that is said in reference to the electronic device also applies mutually to the method, and vice versa.

The basic concept of the present invention consists of the fact that, in a flexible electronic device that is bendable, at least in regions, in at least one bending direction, the bending can be utilized in order to control or to operate the electronic device.

According to the first aspect of the invention, a flexible electronic device is provided, which is bendable, at least in regions, in at least one bending direction. The flexible electronic device has at least one bending sensor element for detecting the bending state of at least one region of the flexible electronic device. In addition, the flexible electronic device has a control mechanism for converting the bending values detected by the at least one bending sensor element into control commands.

According to the present invention a flexible electronic device is provided, which is bendable, at least in regions, in at least one bending direction. Consequently, the electronic device can also be designated as bending-flexible. Basically, it is sufficient for the invention, if the electronic device is bendable in only one bending direction. Of course, it may also be provided advantageously that the electronic device is bendable in several bending directions. Also, it is basically sufficient if only one region of the electronic device is bendable. Of course, it can also be provided that the entire electronic device in and of itself is bendable. In this respect, the invention is not limited to specific forms of embodiment of the electronic device. Several advantageous, but non-exclusive examples will be explained in more detail in the further course of the description.

In one embodiment, it may be provided, for example, that the flexible electronic device is bendable along the vertical axis, at least in regions. In another embodiment, it may be provided, for example, that the flexible electronic device is bendable along the horizontal axis, at least in regions. Of course, it may also be provided that the flexible electronic device is bendable, at least in regions, both along the vertical axis as well as along the horizontal axis.

The flexible electronic device is first of all characterized in that it has at least one bending sensor element for detecting the bending state of at least one region of the electronic device. It can basically be freely selected as to where the bending sensor element is provided at/in the electronic device. For example, the bending sensor element can be provided or disposed inside and/or outside the electronic device. Advantageously, however, the at least one bending sensor element is found inside the electronic device. The bending sensor element is assigned to the region whose bending state will be measured or formed, respectively. For example, the bending sensor element can be disposed, designed, etc., directly in the region whose bending state will be measured or detected, respectively. Of course, embodiments are also conceivable, in which the bending sensor element can also be placed somewhere else. Then the bending sensor element must be able to measure or detect, respectively, a bending in the region to which it is assigned. Generally, it is sufficient if one bending sensor element is assigned to a region whose bending state will be measured or detected, respectively. Of course, two or more bending sensor elements may also be assigned to the latter. The arrangement and number of bending sensor elements utilized also depends on their configuration.

The present invention is not limited to a specific number, arrangement or configuration of the bending sensor elements. It is only important that the bending sensor element is sensitive to bending so that it can accurately detect a bending of the region of the electronic device that is to be monitored. Several advantageous, but non-exclusive examples of suitable bending sensor elements will be explained in more detail in the further course of the description.

It is basically sufficient if the flexible electronic device has a single bending sensor element. Advantageously, however, the flexible electronic device provides two or more bending sensor elements. These can be distributed advantageously over the entire electronic device. Of course, it is also conceivable that the bending sensor elements are provided only in specific regions of the electronic device.

Finally, the flexible electronic device according to the invention also provides a control mechanism, which serves for controlling the electronic device. In particular, the control mechanism has the function of converting the bending values detected by the at least one bending sensor element into control commands. The electronic device will then be controlled by means of these control commands. How this is done in individual steps will be explained in detail in the further course of the description. The control mechanism can be configured in a flexible manner, for example, and for this purpose can be disposed/formed, for example, on a flexible plate.

The control mechanism produces corresponding control commands based on the detected bending values. These may involve, for example, control commands that are provided for operating, for handling, for manipulating, etc. the electronic device. Of course, they may also involve control commands in connection with an input of content or, however, with the triggering of actions.

The flexible electronic device according to the invention now has particularly configured input means that are constructed in the form of bending sensor elements. Control commands, by means of which the electronic device is controlled, are generated in the control mechanism via a bending of the electronic device, and the bending values that are detected by the bending sensor elements relative thereto. Thus, a direct and intuitive interaction between the user and the electronic device is possible, without needing to have recourse to previously common operating elements with technical appearance, such as switches, knobs, controllers, or similar elements. Therefore, the input solution according to the invention has the further advantage that it does not contribute to an overall technical appearance of the electronic device. The control commands are now generated only by bending the flexible electronic device without having to change its holding position.

The core of the solution according to the invention thus consists in the use of the flexibility of novel electronic devices, for example, those in the form of display systems, as an input function.

The basic functioning of a flexible electronic device according to the invention will now be explained in more detail based on a non-exclusive example. For example, it may be desired that only a limited input possibility will be provided by the bending of the flexible electronic device. For example, it is conceivable that only three basic bending states will be recognized. These may involve, for example, the states: “not bent”, “concavely bent” or “convexly bent”. In this way, in addition to the “not bent” state, two other principal states can be distinguished, namely, “bent upward” and “bent downward”. In such a case, the bending could generate only basic control commands.

As has been stated above, the present invention is not limited to specific embodiments for the flexible electronic device. In this respect, several advantageous, but non-exclusive examples will be named below. For example, it is conceivable that the flexible electronic device is designed as a flexible display appliance. For example, a flexible display appliance may involve a flexible image screen, a flexible display or similar device.

For example, so-called electronic paper also belongs to the category of flexible display. Electronic paper, abbreviated e-paper (English: e-paper) is a digital display technology similar to paper that is for the most part based on electrophoretic technology. E-paper comprises an electrically conducting sheet, which contains small cells and which is introduced on a bright, often white background. Color pigment particles in these cells react to electrical voltage. By introducing a voltage, the presentation on the e-paper can be changed from cell to cell, whereupon an overall digital image of all cells is formed. When compared with conventional displays, e-paper combines the advantages of electronic displays and paper, whereby a high contrast ratio almost equal to that of paper can also be obtained even without background illumination. In addition, the display can be observed independent of viewing angle and also can be introduced on a very thin, flexible substrate.

Preferably, the flexible electronic device can be designed as a mobile information-processing apparatus, in particular as an information apparatus and/or reading apparatus. In the case of a reading apparatus, the flexible electronic device might involve, for example, an electronic book, an electronic newspaper or similar item, whereby such a reading apparatus is then advantageously designed in the form of a display based on electronic paper.

Advantageously, the flexible electronic device may have at least two regions, which are bendable independently of one another in at least one bending direction. This means that any region whose bending state will be measured or detected, respectively, independently from another region whose bending state will be measured, can be bent so that the bending processes can be carried out decoupled from one another, i.e., without affecting one another, without overlapping, etc. In this way, the detection of a large number of different bending states is possible, and thus it is possible to generate a large number of different control commands. The individual bending of each region to which a bending sensor element is assigned can then be utilized for generating a control command. In particular, bendings of the bending sensor elements in the same direction can be utilized, but also they can be used when bending in opposite directions, in order to generate control commands.

In an advantageous configuration, it may be provided that at least one bending sensor element is designed for detecting the bending state in at least one edge region of the flexible electronic device. This is then particularly of advantage, if the electronic device is designed as a flat structure as described above. If the bending of the edge region is detected and converted to control commands in the control mechanism, a very simple operation of the electronic device can be executed in this way.

Advantageously, the flexible electronic device may have at least two edge regions, whereby the edge regions are designed so they are bendable independently of one another. In order to detect the bending state of the edge regions, advantageously at least one bending sensor element is then assigned to each edge region. For example, it may be provided that each edge region, independently of every other edge region, can be bent upward or can be bent downward. In this way, first the bending states, “not bent”, “bent upward”, “bent downward” as well as also the intermediate phase, “is bent straight” can be detected by the bending sensor elements for each edge region. In this way, a coupling could also be executed in that both edge regions are only bent either upward or downward simultaneously. The above-described configuration, however, additionally makes possible yet another degree of freedom. It means that the edge regions can be bent independently of one another, so that the edge regions can simply be bent upward or downward independently of one another. It is also possible that the edge regions can be bent in opposite directions. In this way, the number of control commands that can be generated and carried out and which are based only on the bending of the device, can be considerably increased.

The flexible electronic device, which can be designed, for example, as a flexible display appliance, can be configured in different ways. Several advantageous, but non-exclusive examples will be explained in more detail below for this purpose.

For example, the flexible electronic device may have a four-cornered basic contour, for example, a four-cornered basic surface, which is bounded by two side edges. In order to detect the bending state of at least one side edge, at least one bending sensor element can be assigned to the corresponding side edge to detect the bending state. Basically, one bending sensor element is sufficient. Two or more bending sensor elements, however, may also be provided. Advantageously, the bending states named above can be measured or detected, respectively, with each bending sensor element. From the perspective of the user, the side edges can be bent upward or downward, which corresponds to a vertical bending around an axis that extends parallel to the side edges. An embodiment is thus advantageous in which at least one bending sensor element is assigned to each side edge in order to detect the bending state of both side edges. Thus, both side edges can simply be bent upward or downward independently of one another, and, in fact, in opposite directions.

In another configuration, it may be provided that the flexible electronic device has a four-cornered basic contour, for example, a four-cornered basic surface, which is bounded by an upper edge and by a lower edge. In order to detect the bending state of the upper edge and/or of the lower edge, at least one bending sensor element is then assigned to the corresponding edge, thus to the upper and/or lower edge. Basically, here again, at least one bending sensor element is sufficient. Two or more bending sensor elements, however, may also be provided. Advantageously, the bending states named above can be measured or detected, respectively, with each bending sensor element. From the perspective of the user, the edges then can be bent upward or downward, which corresponds to a bending frontward or backward and thus to a horizontal bending around an axis that extends parallel to the upper and lower edges. In this way, an embodiment is advantageous, in which at least one bending sensor element is assigned to an edge for detecting the bending state of the edge. Thus, the upper edge and/or the lower edge simply can be bent upward or downward independently of one another, and, in fact, in opposite directions.

An embodiment is particularly advantageous, in which the flexible electronic device has a four-cornered basic contour, for example, a four-cornered basic surface, which is bounded by two side edges, an upper edge and a lower edge. In order to detect the bending state of at least one side edge and/or the upper edge and/or the lower edge, at least one bending sensor element can be assigned to the corresponding edge. This makes possible both vertical bendings of edges as well as horizontal bendings of edges. Since each bending can be generated independently, the number of possible control commands that can be generated or executed, respectively, in this way is particularly large, as is described above in detail, so that reference is made to the full extent to the corresponding statements.

For example, the flexible electronic device can be designed as a flat structure, in which the flat structure can advantageously have a four-cornered basic contour, in particular a rectangular basic contour. Such an electronic device then has a basic surface, which is bounded by two side edges, an upper edge and a lower edge. The basic surface in such a case can serve as a display appliance for presenting information—e.g., texts, images, etc. For example, in this case, it may be provided that at least one side edge is bendable at least in regions around the vertical axis. Alternatively or additionally, it may be advantageously provided that the upper edge and/or the lower edge is/are bendable around the horizontal axis, at least in regions.

It can be provided advantageously that the flexible electronic device has a mechanism for the at least temporary deactivation of the at least one bending sensor element. Alternatively or additionally, it can be provided that a mechanism is provided for the at least temporary blocking of the conversion of the detected bending values into control commands. In this way, it is assured that an unintentional bending of the electronic device does not lead to an unwanted generation of control commands as soon as the mechanism is activated.

As has been discussed above, the present invention is not limited to specific types of bending sensor elements. Several advantageous, but non-exclusive examples of suitable bending sensor elements will be described below for this purpose.

For example, it may be provided that at least one bending sensor element is designed as an optical bending sensor element. Optical bending sensor elements are already known in and of themselves in the prior art in applications in other technical fields. An optical bending sensor element is basically characterized in that an optical attenuation that arises due to bending is measured. For this purpose, it is often provided that the optical bending sensor element is designed in the form of optical fibers. This type of optical bending sensor element often comprises one or more optical waveguides or fibers, which is (are) provided with a surface structure such that it brings about a waveguide attenuation that is a function of bending when the optical waveguide is bent. Such a solution is described, for example, in DE 10 2005 033 120 A1 or DE 10 2005 047 738 A1, the disclosure content of which is incorporated to this extent in the description of the present invention.

In another configuration, at least one bending sensor element can be designed as a bending-sensitive sensor strip. For example, the pulling, pressing or a corresponding torsion that arises when such a sensor strip is bent can be detected. Of course, it is also conceivable that the sensor strip is designed as a fiber, as has been described above.

Advantageously, it may also be provided that at least one bending sensor element is designed as an piezoelectric bending sensor element. These types of bending sensor elements are already known in and of themselves in the prior art in applications in other technical fields. For example, at least one bending element of piezoelectric material is provided. If forces act on the sensor element, the sensor element is deflected, whereby a charge shift occurs due to the piezoelectric effect, which has as a consequence a positive or negative electrical charge at the surface of the sensor element. Such piezoelectric bending sensor elements are described, for example, in DE 195 25 147 A1 or DE 197 45 311 C1, the disclosure content of which is incorporated to this extent in the description of the present invention.

In another configuration, an input device can be provided for inputting control commands. For example, it may be provided that only several basic control commands can be generated via the above-described configuration. In such a case, it may be desirable to provide additional, detailed control commands, and thus input possibilities, for operating the flexible electronic device. This can be carried out via the input apparatus. For example, in this connection it is conceivable that support control commands, which serve as supporting and/or additional control commands to those control commands generated by means of bending, can be generated via the input apparatus. The input apparatus can thus serve for the input or generation of further control commands, which start from the control commands that can be generated or executed, respectively, by means of the bending sensor element.

According to the second aspect of the invention, a method for controlling an electronic device that is bendable, at least in regions, in at least one bending direction is provided, the method being characterized by the following steps: a) the bending state of at least one region of the flexible electronic device is detected by means of at least one bending sensor element which is present in the flexible electronic device; b) the bending values detected by the at least one bending sensor element are further conducted to a control mechanism of the flexible electronic device; c) bending values detected by the at least one bending sensor element are converted in the control mechanism into control commands for the flexible electronic device.

Such a method provides a particularly advantageous, simple input method for flexible electronic devices.

It may be advantageously provided that the method is designed for controlling a flexible electronic device designed as a flexible display appliance, in particular for controlling the presentation of content on/in the flexible display appliance.

Advantageously, the method for controlling a flexible electronic device as described above according to the invention is designed so that relative to execution and functioning of a corresponding method, reference is made to the full extent to the above statements for the flexible electronic device.

The invention will now be explained in more detail on the basis of embodiment examples with reference to the appended drawings. Herein:

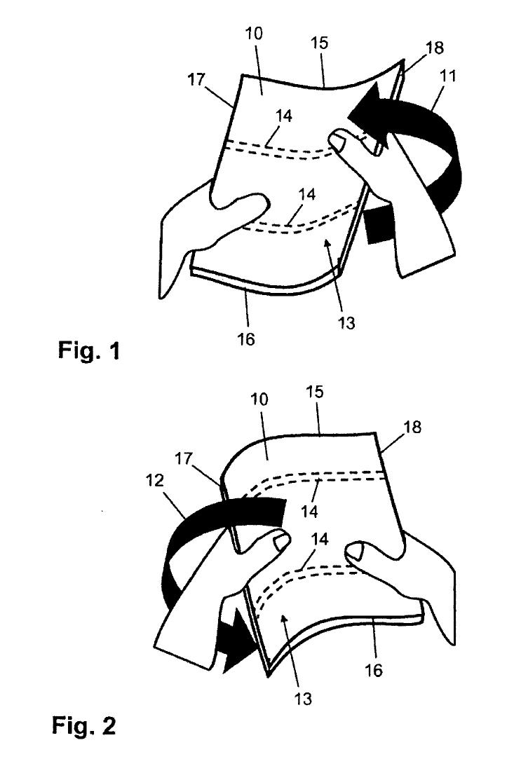

FIG. 1 shows a first example of embodiment of a flexible electronic device according to the invention in a first bending state;

FIG. 2 shows the flexible electronic device of FIG. 1 according to the invention in a second bending state;

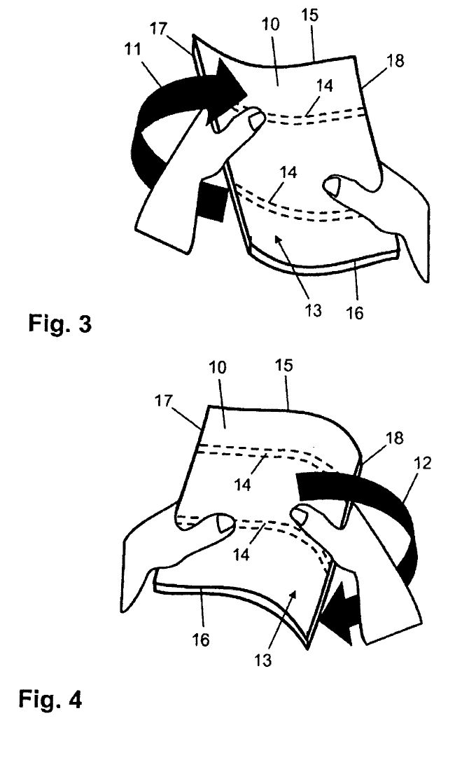

FIG. 3 shows the flexible electronic device of FIG. 1 according to the invention in a third bending state;

FIG. 4 shows the flexible electronic device of FIG. 1 according to the invention in a fourth bending state;

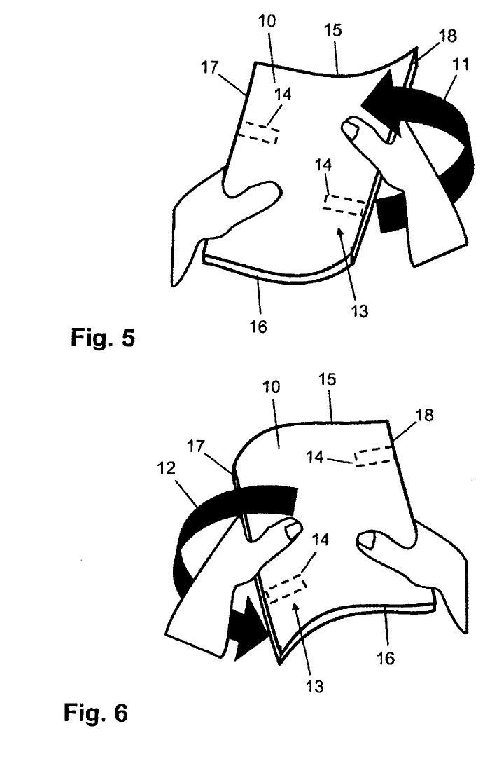

FIG. 5 shows a second example of embodiment of a flexible electronic device according to the invention in a first bending state;

FIG. 6 shows the flexible electronic device of FIG. 5 according to the invention in a second bending state;

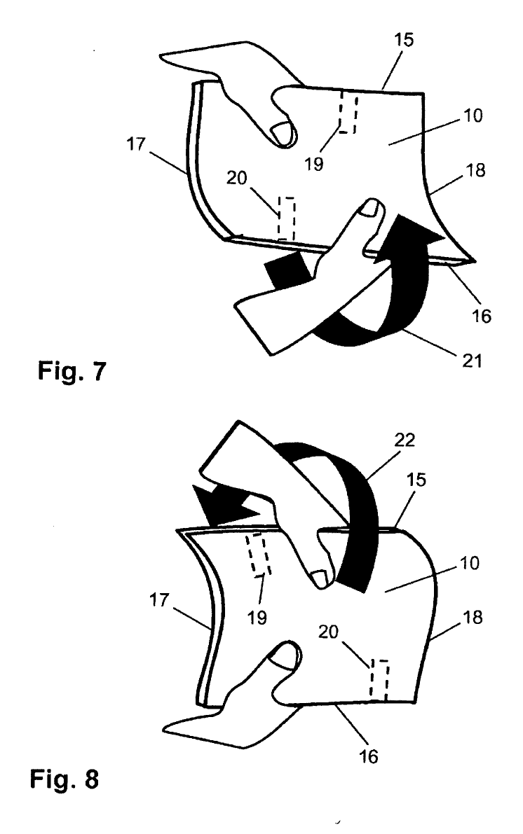

FIG. 7 shows a third example of embodiment of a flexible electronic device according to the invention in a first bending state; and

FIG. 8 shows the flexible electronic device of FIG. 7 according to the invention in a second bending state.

In each of FIGS. 1 to 4, a flexible electronic device 10 is shown, which is designed in the form of a flexible display appliance, e.g., an electronic newspaper or similar device. The electronic device 10 has a basic rectangular contour, with two side edges 17, 18, an upper edge 15, and a lower edge 16. The flexible electronic device 10 can be bent in different bending directions. Two bending directions are shown for clarification in the examples. These involve a bending along the vertical axis. On the one hand, bending can be produced upward (bending direction 11). On the other hand, bending can also be produced downward (bending direction 12). The flexible electronic device 10 in FIGS. 1 to 4 is configured in such a way that it can be bent upward and/or downward each time in its edge regions 13 of side edges 17, 18.

Alternatively or additionally, of course, it may also be provided that the upper edge 15 and/or the lower edge 16 can be bent upward and/or downward. This bending is then advantageously produced around the horizontal axis.

Bending sensor elements 14 are provided in electronic device 10 in order to be able to detect a bending of flexible electronic device 10. In the examples shown, two such bending sensor elements 14 are shown each time, whereby the invention, of course, is not limited to a specific number of bending sensor elements 14. The bending sensor elements 14, which are shown in the examples, are designed in the form of sensor strips that extend over the entire width* of electronic device 10, and thus also in its edge regions 13. Bending sensor elements 14 can be designed, for example as optical-fiber sensor elements, as piezoelectric sensor elements or similar types. The present invention is not limited to specific types of sensor elements. Likewise, the invention is not limited to specific embodiments of such sensor elements. *in the first embodiment example—Translator's note.

Flexible electronic device 10, in addition, has a control mechanism (not shown), by means of which the operation of device 10 is controlled. The control mechanism is also designed to be flexible in this case.

The basic functioning of operation of flexible electronic device 10 is as follows. If electronic device 10 is bent in its edge region 13 in bending directions 11 and/or 12, the corresponding bending state of electronic device 10 is detected by bending sensor elements 14. The detected bending values are transmitted to the control device and converted therein into control commands for flexible electronic device 10.

In principle, two states can be distinguished in the examples shown in Figures I to 4. On the one hand, edge regions 13 can be bent upward (FIGS. 1 and 3), and, on the other hand, edge regions 13 can be bent downward (FIGS. 2 and 4). For example, basic control commands can be generated by means of such bending of flexible electronic device 10.

Several examples will be described below in this respect. Thus, for example, it may be meaningful to generate a scroll forward one page or a scroll back one page by bending the edge regions 13. Of course, it may be possible that alternative actions can also be triggered via the bending process depending on the context. For example, the described control can trigger actions, such as, for example, “Display the following element/Display the previous element” or “Move forward one page/Move back one page”, or “Shift content (scroll)” or “Start media flows or allow media flows to continue/Stop or pause media flows,” and similar actions.

For example, it can be provided that side edge regions 13 can be bent along the vertical axis. Alternatively or additionally, it may also be provided that upper edge 15 and/or lower edge 16 can be bent around the horizontal axis. In the last-named case, for example, the upper edge (upper edge 15) and/or the lower edge (lower edge 16) of device 10 can be held and bent up or down. Advantageously, device 10 is designed in such a way that a bending in the vertical direction, a bending in the horizontal direction, or a combination of bending in the horizontal and vertical directions is possible. A horizontal bending could then be carried out, for example, an up/down scrolling. A vertical bending could then mean, for example, a page turning.

It might be difficult to be able to distinguish a bending in the left edge region and in the right edge region. In such a case, it would then only be necessary to distinguish whether the flexible electronic device is bent upward or downward.

Several possible input options and possible subsequent options will be described below. For example, a bending up on the right side (FIG. 1) and a bending down on the left side (FIG. 2) of flexible electronic device 10 could lead to the following control commands: Go to the next element, Move forward one page; Scroll content from right; Stream content or continue streaming, or similar commands. In a similar way, a bending up on the left side (FIG. 3) and a bending down on the right side (FIG. 4) of flexible electronic device 10 could lead to the following control commands: Go to the previous element; Move back one page; Scroll content from left; Interrupt/pause a streaming, or similar commands.

An example of embodiment is shown in FIGS. 5 and 6, in which flexible electronic device 10 has more than two* bending sensor elements 14. Two bending sensor elements 14 are assigned to each side edge 17 or 18, respectively, whereby bending sensor elements 14 are disposed in the region of side edges 17, 18 or are designed according to the configuration in each case. Of course, more than two bending sensor elements 14 per side edge 17, 18 can also be provided, whereby, of course, one bending sensor element 14 per side edge 17 may also be sufficient. In this way, side edges 17, 18, which can be bent independently of one another, assume a plurality of bending states, for example, “not bent”, “bent upward”, “bent downward”, as well as also the intermediate phase, “is bent straight.” The above described configuration, however, additionally makes possible yet another degree of freedom. This means that side edges 17, 18 can be bent independently of one another, so that they can also be bent in opposite directions. In this way, the number of control commands that can be generated and carried out and which are only based on the bending of the device, is considerably increased. *sic; two are shown—Translator'note.

Flexible electronic device 10, as it is shown in FIGS. 1 to 6, has a four-cornered basic contour, for example, a four-cornered basic surface, which is bounded by two side edges 17, 18. In order to detect the bending state of at least one side edge 17, 18, at least one bending sensor 14 element is assigned to the corresponding side edge 17, 18. The bending states named above can be measured or detected, respectively, with each bending sensor element 14. From the perspective of the user, the side edges 17, 18 can then be bent upward—shown by arrow 11, or downward—shown by arrow 12, which corresponds to a vertical bending around an axis that extends parallel to side edges 17, 18. Thus, both side edges 17, 18 simply can be bent upward or downward independently of one another, and, in fact, each in opposite directions.

In FIGS. 7 and 8, a flexible electronic device 10 is shown that for the most part corresponds to device 10 shown in FIGS. 1 to 6. Flexible electronic device 10, which is shown in FIGS. 7 and 8, also has a four-cornered basic contour, for example, a four-cornered basic surface, which is bounded by an upper edge 15 and by a lower edge 16. In order to detect the bending state of upper edge 15 and/or of lower edge 16, at least one bending sensor element 19, 20 is then assigned to the corresponding edge 15, 16 thus to the upper and/or lower edge. Basically, here again, at least one bending sensor element 19, 20 is sufficient. Two or more bending sensor elements 19, 20, however, may also be provided in each case. Advantageously, the bending states named above can be measured or detected, respectively, with each bending sensor element 19, 20. From the perspective of the user, side edges 15, 16 can then be bent upward—shown by arrow 21, or downward—shown by arrow 22, which corresponds to a bending frontward or backward and thus to a horizontal bending around an axis that extends parallel to upper edge 15 and lower edge 16. In this way, an embodiment is advantageous, in which at least one bending sensor element 19, 20 is assigned to an edge 15, 16 in order to detect the bending state of the edge. Thus, upper edge 15 and/or lower edge 16 can simply be bent upward or downward independently of one another, and, in fact, in opposite directions.

An embodiment is particularly advantageous, in which flexible electronic device 10 has a four-cornered basic contour, for example, a four-cornered basic surface, which is bounded by two side edges 17, 18, an upper edge 15 and a lower edge 16. In order to detect the bending state of at least one side edge 17, 18, and/or the upper edge 15 and/or the lower edge 16, at least one bending sensor element 14, 19, 20 can be assigned to the corresponding edge. This makes possible both vertical bendings of edges as well as horizontal bendings of edges. Since each bending can be produced independently, the number of possible control commands that can be generated or executed, respectively, in this way is particularly large.

The basic concept of flexible electronic device 10 according to the invention corresponding to FIGS. 1 to 8 consists in using the flexibility of electronic device 10 as an input function, wherein input is produced by bending flexible electronic device 10.

### LIST OF REFERENCE SYMBOLS

10 Flexible electronic device

11 Bending direction (vertical bending)

12 Bending direction (vertical bending)

13 Edge region of the flexible electronic device

14 Bending sensor element

15 Upper edge of the flexible electronic device

16 Lower edge of the flexible electronic device

17 Side edge of the flexible electronic device

18 Side edge of the flexible electronic device

19 Bending sensor element

20 Bending sensor element

21 Bending direction (horizontal bending)

22 Bending direction (horizontal bending)

1. A flexible electronic device that is bendable, at least in regions, in at least one bending direction having at least one bending sensor element for detecting the bending state of at least one region of flexible electronic device and having a control mechanism for converting the bending values detected by the at least one bending sensor element into control commands.

2. The flexible electronic device according to claim 1, further characterized in that it is designed as a flexible display appliance.

3. The flexible electronic device according to claim 1, further characterized in that it is designed as a mobile information-processing appliance, in particular as an information apparatus and/or reading apparatus.

4. The flexible electronic device according to claim 1, further characterized in that it has at least two regions that are bendable independently of one another in at least one bending direction.

5. The flexible electronic device according to claim 1, further characterized in that at least one bending sensor element is designed for detecting the bending state in at least one edge region of flexible electronic device.

6. The flexible electronic device according to claim 1, further characterized in that it has at least two edge regions, that edge regions are designed bendable independently of one another and that in order to detect the bending state of edge regions, at least one bending sensor element is assigned to each edge region.

7. The flexible electronic device according to claim 1, further characterized in that it has a four-cornered basic contour that is bounded by two side edges, and that in order to detect the bending state of at least one side edge, at least one bending sensor element is assigned to the corresponding side edge.

8. The flexible electronic device according to claim 7, further characterized in that, in order to detect the bending state of both side edges, at least one bending sensor element is assigned to each side edge.

9. The flexible electronic device according to claim 1, further characterized in that it has a four-cornered basic contour, which is bounded by an upper edge and by a lower edge, and that in order to detect the bending state of upper edge and/or of lower edge, at least one bending sensor element is assigned to the corresponding edge.

10. The flexible electronic device according to claim 1, further characterized in that a mechanism is provided for the at least temporary deactivation of the at least one bending sensor element and/or for the at least temporary blocking of the conversion of the detected bending values into control commands.

11. The flexible electronic device according to claim 1, further characterized in that at least one bending sensor element is designed as an optical bending sensor element and/or as a bending-sensitive sensor strip and/or as a piezoelectric bending sensor element.

12. The flexible electronic device according to claim 1, further characterized in that an input device is provided for inputting control commands.

13. A method for controlling a flexible electronic device that is bendable, at least in regions, in at least one bending direction, characterized by the following steps:
a) the bending state of at least one region of flexible electronic device is detected by means of at least one bending sensor element, which is present in flexible electronic device;
b) the bending values detected by the at least one bending sensor element are further conducted to a control mechanism of flexible electronic device;
c) bending values detected by the at least one bending sensor element are converted into control commands for flexible electronic device in the control mechanism.

14. The method according to claim 13, further characterized in that it is configured for controlling a flexible electronic device designed as a flexible display appliance, in particular for controlling the presentation of content on/in the flexible display appliance.

15. The method according to claim 13, further characterized in that it is designed for controlling a flexible electronic device that is bendable, at least in regions, in at least one bending direction having at least one bending sensor element for detecting the bending state of at least one region of flexible electronic device and having a control mechanism for converting the bending values detected by the at least one bending sensor element into control commands.
